(19) United States
(12) Patent Application Publication
(10) Pub. No.: US 2011/0221965 A1
(43) Pub. Date: Sep. 15, 2011

(54) DEGRADING A VIDEO

(76) Inventors: April Slayden Mitchell, San Mateo, CA (US); Mitchell Trott, San Mateo, CA (US); W. Alex Vorbau, Los Altos, CA (US)

(21) Appl. No.: 13/122,434

(22) PCT Filed: Oct. 7, 2008
(86) PCT No.: PCT/US08/79045

§ 371 Date: May 16, 2011

(51) Int. Cl. H04N 9/64

(52) U.S. Cl. 348/575; 348/E09.037

(57) ABSTRACT

Monitoring [205] a usage characteristic of a video [110] in memory is described. The usage characteristic is based at least in part on access to the video [110] while stored in memory. Based on the usage characteristic, the quality of the video [110] is degraded [210], wherein the degraded video [140] requires less memory.

### FIELD

The field of the present invention relates to computing systems. More particularly, embodiments of the present invention relate to video communication systems.

### BACKGROUND

Presently, video services enable the on-line sharing of videos. As users of a video service continue to upload and share videos, in the case of a hosted architecture, these videos must be stored in files on one or more servers. After time, the storage size of these files can grow very large.

Some video services have limitations on how many videos that can be uploaded, how often videos can be uploaded, and how much storage capacity that can be used. Each one of these limitations requires the user to specifically choose which videos are most important to be uploaded as well as which videos are no longer important and may be deleted. Thus, the user may encounter difficult choices.

Similarly, as one continues to upload videos to files on a home personal computer, the storage size of these files becomes very large. However, due to the storage size limitations of these files, one may have to make challenging decisions as to which videos to delete to make room for new videos.

### BRIEF DESCRIPTION OF THE DRAWINGS

The accompanying drawings, which are incorporated in and form a part of this specification, illustrate embodiments of the invention for quick video message generators and, together with the description, serve to explain principles discussed below:

FIG. 1 is a block diagram of an example video reprocessor in accordance with embodiments of the present invention.

FIG. 2 is a flowchart of an example method of reprocessing a video in accordance with embodiments of the present invention.

FIG. 3 is a flowchart of an example computer usable medium wherein instructions thereon, when executed cause a computer system to perform a method of reprocessing a video in accordance with embodiments of the present invention.

FIG. 4 is a diagram of an example computer system used for reprocessing a video in accordance with embodiments of the present invention.

The drawings referred to in this description should not be understood as being drawn to scale unless specifically noted.

### DESCRIPTION OF EMBODIMENTS

Reference will now be made in detail to embodiments of the present invention, examples of which are illustrated in the accompanying drawings. While the invention will be described in conjunction with various embodiment(s), it will be understood that they are not intended to limit the present invention to these embodiments. On the contrary, the present invention is intended to cover alternatives, modifications and equivalents, which may be included within the spirit and scope of the various embodiments as defined by the appended claims.

Furthermore, in the following detailed description, numerous specific details are set forth in order to provide a thorough understanding of the present invention. However, the present invention may be practiced without these specific details. In other instances, well known methods, procedures, components, and circuits have not been described in detail as not to unnecessarily obscure aspects of the present embodiments.

Unless specifically stated otherwise as apparent from the following discussions, it is appreciated that throughout the present detailed description, discussions utilizing terms such as “monitoring”, “degrading”, “presenting”, “continuing”, “reducing”, or the like, refer to the actions and processes of a computer system, or similar electronic computing device. The computer system or similar electronic computing device manipulates and transforms data represented as physical (electronic) quantities within the computer system's registers and memories into other data similarly represented as physical quantities within the computer system memories or registers or other such information storage, transmission, or display devices. The present invention is also well suited to the use of other computer systems such as, for example, optical and mechanical computers.

### OVERVIEW OF DISCUSSION

Embodiments in accordance with the present invention pertain to a video reprocessor (VR) and its usage. In one embodiment in accordance with the present invention, the VR described herein reduces a video's quality over time, thereby increasing available storage for files containing videos.

More particularly, when a user uploads a video file, that file may be converted to several different types of files for playback on web browsers, mobile phones, desktop applications, and the like. When a user views this file, the quality of the video, while limited by the playback mechanism the user has chosen, is at its highest level. If the user continues to watch this file daily or often, the file will retain its high quality during playback. However, if the user does not watch the file for a week, then the file may be downgraded or transcoded to a lower quality based on how long it has been since the creator or anyone else has viewed the video.

The quality of the video will continue to be downgraded until eventually it is only a still image or unrecognizable. At this point, in one embodiment all copies of the video file may be removed from the server. This enables the video server to have more storage capacity for newer videos and removes the need for the user to select old videos to delete.

In another embodiment, the user is prompted to delete the video file. In yet another embodiment, the still image may remain and the video the is never deleted unless the user specifically selects it to be deleted. This enables the user to make more informed and easier decisions about which video file to delete.

Thus, in one embodiment the VR successively degrades the quality of a video to a lower quality via methods such as, but not limited to, reducing the bit rate, frame rate, and/or image size, hence increasing available storage. This degradation is based on usage characteristics such as but not limited to the age of the video, and/or the frequency with which the video is viewed.

Overall, the video's quality decreases with every degradation. Degrading the video's quality has the advantage of increasing available space in a computer's storage. Additionally, the quality of a video may be used as an indicator as to the video's age and/or the frequency with which it was accessed.

### Video Reprocessor

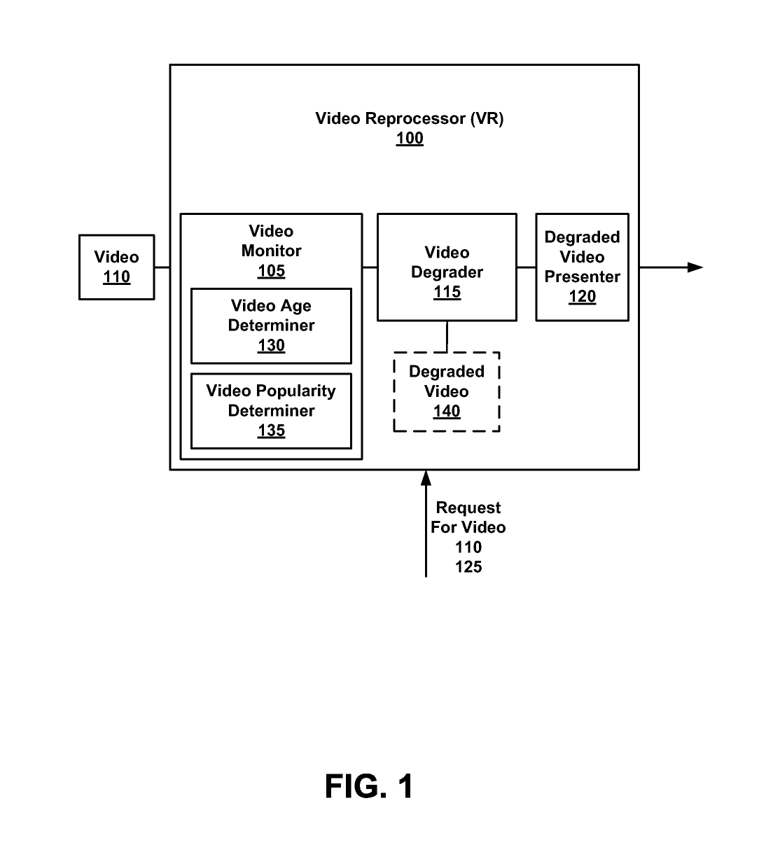

FIG. 1 is a block diagram of an example video reprocessor (VR) 100 in accordance with embodiments of the present invention. VR 100 includes video monitor 105, video degrader 115, degraded video presenter 120, video age determiner 130, and video popularity determiner 135.

With reference to FIG. 1, in one embodiment video monitor 105 is configured to monitor a usage characteristic of video 110 in memory, wherein the usage characteristic is based at least in part on access to video 110 while stored in memory. Video 110 may comprise any type of content capable of being recorded. Of note, video 110 may be representative of any number of videos. The phrase “usage characteristics” refers to information relating to video 110 that is measurable and/or that which may be used or viewed based on this measurable information or measurement itself (e.g., age, size, content, resolution). Memory refers to not only RAM and ROM, but to other memory sources, such as memory stored on a device coupled with VR 100. For example, a device coupled with VR 100 may be a Network Attached Storage device.

Video 110 may be accessed at a predetermined point in time, or in response to a request for viewing video 110. For example, video 110 may be scheduled to be accessed at the predetermined time of 8:00 a.m. every day. In other embodiment, when video 110 is requested to be viewed, video monitor 105 is then prompted to monitor video 110.

Referring still to FIG. 1, in one embodiment video degrader 115 is configured to degrade video 110 based on monitored usage characteristics of video 110, wherein the degraded video requires less memory. The term, “degrade”, refers to reducing the quality of video 110 as viewed. Video's 110 quality may be reduced by any number of means, such as but not limited to the following: reducing video's 110 bit rate, reducing video's 110 frame rate, and/or reducing video's 110 image size. Thus, after video 110 has been degraded, the next time that video 110 is requested to be presented, degraded video 140 becomes the video that is available to be viewed.

In one embodiment, video monitor 105 is coupled with video age determiner 130 and video popularity determiner 135. Video age determiner 130 is configured to determine the age of video 110. The age of video 110 may be that which is calculated from a predetermined starting point (e.g. the point at which video 110 is saved/created on a user's computer or uploaded to a server, and/or a predetermined point at which to start calculating the age of video 110).

In one embodiment, video degrader 115 degrades video 110 based on the age of video 110. For example, it may be predetermined that video 110 is to be degraded once a week. If video age determiner 130 determines that video 110 has reached the one week mark, then video age determiner 130 alerts video degrader 115 to degrade video 110. Video degrader 115 then accesses and degrades video 110 by reducing video's 110 bit rate, in one embodiment.

In another embodiment of the present invention, video popularity determiner 135 is configured to determine the frequency with which video 110 is requested to be presented. For example, it may be predetermined that video 110 is to be degraded if video 110 is not requested to be presented within a predetermined time limit a predetermined number of times. In furtherance of this example, suppose video 110 is predetermined to be degraded if it is not requested to be presented five times within a month's span of time. If video 110 is requested to be presented only four times within a month's span of time, then video degrader 115 will access and then degrade video 110 by reducing video's 110 bit rate and image size, in one embodiment.

A video's 110 image size may influence the timing and/or frequency with which VR 100 degrades video 110. In one embodiment, a very large video may be considered for degradation more quickly than smaller video. In another embodiment, the degree of video's 110 resolution may influence the timing and/or frequency with which VR 100 degrades video 110. For example, a video with a high resolution may be degraded before a video with a low resolution.

Video popularity determiner 135 then continues to track the number of times that video 110 is requested to be presented within a predetermined period of time thereafter. For example, while tracking the time having elapsed during a month's time, video popularity determiner 135 also tracks the number of requests to present video 110. If video 110 is not requested to be presented a certain predetermined amount of times within the month's time, then video popularity determiner 135 may alert video degrader 115 to degrade video 110. In other words, video popularity determiner 135 alerts video degrader 115 of the need to degrade video 110 when video 110 is requested to be presented below a predetermined frequency threshold.

In one embodiment, video degrader 115 continues to degrade video 110 until is only a still image or unrecognizable. For example, video degrader 115 accesses video 110 and then degrades video 110. Video degrader 115 may then access the degraded video 140, and degrade the degraded video 140. As such, the quality of video 110 will continue to decrease until it either becomes a still image or becomes unrecognizable. At this point, all copies of video 110 may be removed from the video server. This enables the video server to have more storage capacity for newer videos and removes the need for the user to select old videos to delete.

In one embodiment, the timing for continued degradation of video 110 may be extended. Overall, the timing, the number of times in which video 110 is requested to be presented, and the quality of degradation may be adjustable parameters based on implementation choices.

In another embodiment of the present invention, degraded video presenter 120 is configured to present degraded video 140. In one embodiment, degraded video presenter 120 presents degraded video 140 to the user of VR 100. The term “presents” refers to providing access to degraded video 140 such that degraded video 140 is accessible for viewing. Of note, while degraded video 140 may be requested to be presented, degraded video 140 may not actually be viewed even though it is accessible for viewing.

Degraded video 140 then becomes the video that video monitor 105 monitors and that video degrader 115 accesses and subsequently degrades. In other words, what was once video 110 is now degraded video 140. Degraded video 140 takes the place of video 110, and becomes the video that is available for being presented upon request.

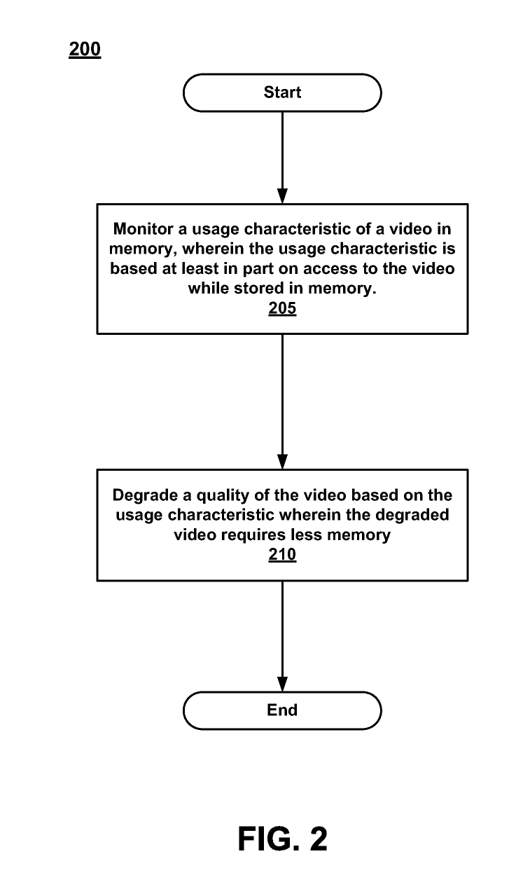

FIG. 2 is a flowchart illustrating a process 200 for reprocessing a video, in accordance with one embodiment of the present invention. In one embodiment, process 200 is carried out by processors and electrical components under the control of computer readable and computer executable instructions. The computer readable and computer executable instructions reside, for example, in data storage features such as computer usable volatile and non-volatile memory. However, the computer readable and computer executable instructions may reside in any type of computer readable medium. In one embodiment, process 200 is performed by system 100 of FIG. 1.

With reference to 205 of FIG. 2, in one embodiment, a usage characteristic of video 110 in memory is monitored, wherein the usage characteristic is based at least in part on access to video 110 while stored in memory. With reference to 210 of FIG. 2, in one embodiment, the quality of video 110 is degraded based on the monitored characteristics of video 110. In one embodiment, video 110 is degraded based on its age. In another embodiment, video 110 is degraded based on the frequency with which it is requested to be presented. In one embodiment, video 110 is degraded by, but not limited to the following: its bit rate being reduced, its frame rate being reduced, and/or its image size being reduced.

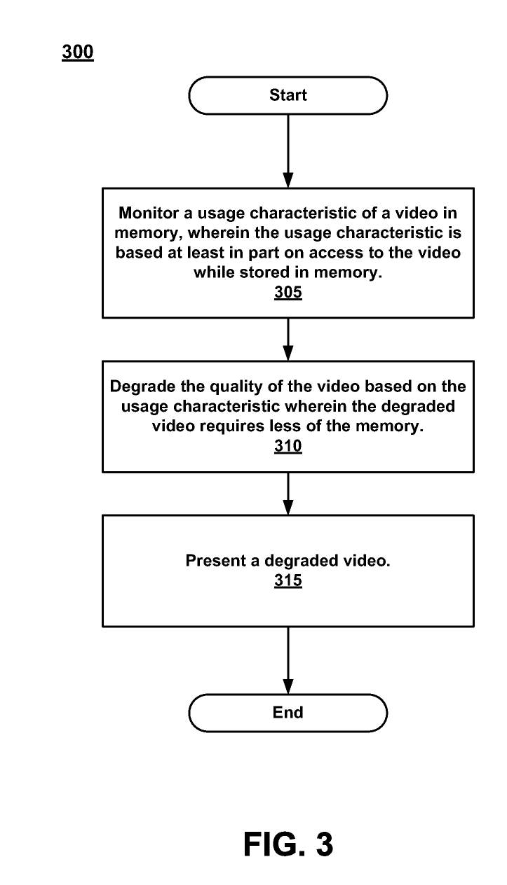

Referring now to FIG. 3, a flowchart of an example computer usable medium wherein instructions thereon, when executed cause a computer system to perform a method of reprocessing a video is shown in accordance with embodiments of the present invention.

With reference now to 305 of FIG. 3, in one embodiment a usage characteristic of video 110 in memory is monitored, wherein the usage characteristic is based at least in part on access to video 110 while stored in memory. With reference to 310 of FIG. 3, in one embodiment, the quality of video 110 is degraded based on a monitored usage characteristic of video 110 wherein the degraded video requires less of the memory. With reference to 315 of FIG. 3, in one embodiment, degraded video 140 is presented.

### Example Computer System Environment

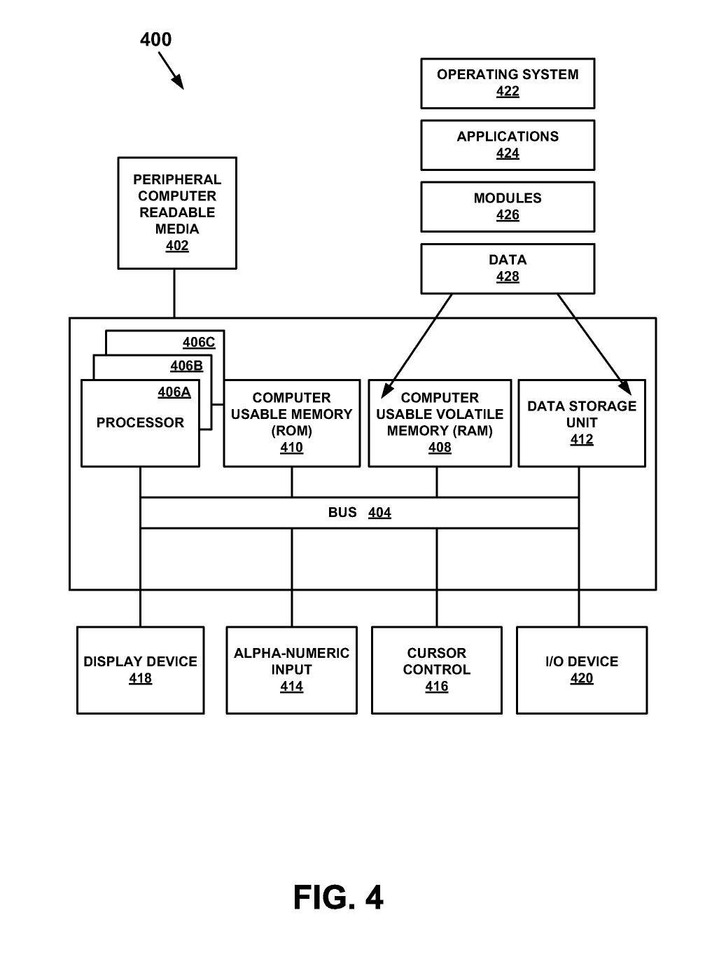

With reference now to FIG. 4, portions of the invention for reprocessing a video are composed of computer-readable and computer-executable instructions that reside, for example, in computer-usable media of a computer system. That is, FIG. 4 illustrates one example of a type of computer that can be used to implement embodiments, which are discussed below, of the present invention.

FIG. 4 illustrates an example computer system 400 used in accordance with embodiments of the present invention. It is appreciated that system 400 of FIG. 4 is an example only and that the present invention can operate on or within a number of different computer systems including general purpose networked computer systems, embedded computer systems, routers, switches, server devices, user devices, various intermediate devices/artifacts, stand alone computer systems, and the like. As shown in FIG. 4, computer system 400 of FIG. 4 is well adapted to having peripheral computer readable media 402 such as, for example, a compact disc, and the like coupled therewith.

System 400 of FIG. 4 includes an address/data bus 404 for communicating information, and a processor 406A coupled to bus 404 for processing information and instructions. As depicted in FIG. 4, system 400 is also well suited to a multi-processor environment in which a plurality of processors 406A, 406B, and 406C are present. Conversely, system 400 is also well suited to having a single processor such as, for example, processor 406A. Processors 406A, 406B, and 406C may be any of various types of microprocessors. System 400 also includes data storage features such as a computer usable volatile memory 408, e.g. random access memory (RAM), coupled to bus 404 for storing information and instructions for processors 406A, 406B, and 406C.

System 400 also includes computer usable non-volatile memory 410, e.g. read only memory (ROM), coupled to bus 404 thr storing static information and instructions for processors 406A, 406B, and 406C. Also present in system 400 is a data storage unit 412 (e.g., a magnetic or optical disk and disk drive) coupled to bus 404 for storing information and instructions. System 400 also includes an optional alpha-numeric input device 414 including alphanumeric and function keys coupled to bus 404 for communicating information and command selections to processor 406A or processors 406A, 406B, and 406C. System 400 also includes an optional cursor control device 416 coupled to bus 404 for communicating user input information and command selections to processor 406A or processors 406A, 406B, and 406C. System 400 of the present embodiment also includes an optional display device 418 coupled to bus 404 for displaying information.

Referring still to FIG. 4, optional display device 418 of FIG. 4 may be a liquid crystal device, cathode ray tube, plasma display device or other display device suitable for creating graphic images and alpha-numeric characters recognizable to a user. Optional cursor control device 416 allows the computer user to dynamically signal the movement of a visible symbol (cursor) on a display screen of display device 418. Many implementations of cursor control device 416 are known in the art including a trackball, mouse, touch pad, joystick or special keys on alpha-numeric input device 414 capable of signaling movement of a given direction or manner of displacement. Alternatively, it will be appreciated that a cursor can be directed and/or activated via input from alpha-numeric input device 414 using special keys and key sequence commands.

System 400 is also well suited to having a cursor directed by other leans such as, for example, voice commands. System 400 also includes an I/O device 420 for coupling system 400 with external entities.

Referring still to FIG. 4, various other components are depicted for system 400. Specifically, when present, an operating system 422, applications 424, modules 426, and data 428 are shown as typically residing in one or some combination of computer usable volatile memory 408, e.g. random access memory (RAM), and data storage unit 412. However, it is appreciated that in some embodiments, operating system 422 may be stored in other locations such as on a network or on a flash drive; and that further, operating system 422 may be accessed from a remote location via, for example, a coupling to the internet. In one embodiment, the present invention, for example, is stored as an application 424 or module 426 in memory locations within RAM 408 and memory areas within data storage unit 412.

Computing system 400 is only one example of a suitable computing environment and is not intended to suggest any limitation as to the scope of use or functionality of the present invention. Neither should the computing environment 400 be interpreted as having any dependency or requirement relating to any one or combination of components in the example computing system 400.

The present invention may be described in the general context of computer-executable instructions, such as program modules, being executed by a computer. Generally, program modules include routines, programs, objects, components, data structures, etc., that perform particular tasks or implement particular abstract data types. The present invention may also be practiced in distributed computing environments where tasks are performed by remote processing devices that are linked through a communications network. In a distributed comp environment, program modules may be located in both local and remote computer-storage media including memory-storage devices.

Thus, embodiments of the present invention provide a method of reprocessing a video containing content such that the age and popularity of the video is indicated. Embodiments of the present invention described herein also aid the user in making selections as to which videos to delete.

Although the subject matter has been described in a language specific to structural features and/or methodological acts, it is to be understood that the subject matter defined in the appended claims is not necessarily limited to the specific features or acts described above. Rather, the specific features and acts described above are disclosed as example forms of implementing the claims.

What is claimed is:

1. A method [200] of reprocessing a video, said method [200] comprising:
monitoring [205] a usage characteristic of a video [110] in memory, wherein said usage characteristic is based at least in part on access to said video [110] while stored in memory; and
degrading [210] a quality of said video [110] based on said usage characteristic wherein degraded video [140] requires less said memory.

2. The method [200] of claim 1, further comprising:
presenting said degraded video [140].

3. The method [200] of claim 1, wherein said degrading [210] is based on an age of said video.

4. The method [200] of claim 1, wherein said degrading [210] is based on a frequency with which said video [110] is requested for presentation.

5. The method [200] of claim 1, further comprising:
continuing to monitor and degrade said video [110].

6. The method [200] of claim 1, wherein said degrading [210] said video [110] comprises:
reducing a hit rate.

7. The method [200] of claim 1, wherein said degrading [210] said video [110] comprises:
reducing a frame rate.

8. The method [200] of claim 1, wherein said degrading [210] said video [110] comprises:
reducing an image size.

9. A video reprocessor (VR) [100] comprising:
a video monitor [105] configured for monitoring a usage characteristic of a video in memory, therein said usage characteristic is based at least in part on access to said video [110] while stored in memory; and
a video degrader [115] configured for degrading said video [110] based on said usage characteristic wherein degraded video [140] requires less said memory.

10. The VR [100] of claim 9, further comprising:
a degraded video presenter [120] configured for presenting said degraded video [140].

11. VR [100] of claim 9, further comprising:
a video age determiner [130] configured for determining an age of said video [110].

12. The VR [100] of claim 9, further comprising:
a video popularity determiner [135] configured for determining a frequency with which said video [110] is requested for presentation.

13. A computer usable medium wherein instructions thereon, when executed cause a computer system to perform a method [300] of reprocessing a video [110], said method [300] comprising:
monitoring [305] a usage characteristic of a video [110] in memory, wherein said usage characteristic is based at least in part on access to said video [110] while stored in memory;
degrading [310] a quality of said video [110] based on said usage characteristic wherein degraded video [140] requires less said memory; and
presenting [315] a degraded video.

14. The computer usable medium of claim 13, wherein said degrading [310] is based on the age of said video [110].

15. The computer usable medium of claim 13, wherein said degrading [310] is based on the frequency with which said video [110] is requested for presentation.
